(19) United States
(12) Patent Application Publication
(10) Pub. No.: US 2018/0290898 A1
(43) Pub. Date: Oct. 11, 2018

(54) METHOD FOR PREPARATION OF RUBIDIUM CESIUM TUNGSTEN BRONZE PARTICLES AND COMPOSITION THEREOF

(71) Applicant: CHIEN-HEN LIN, TAICHUNG (TW)

(72) Inventor: CHIEN-HEN LIN, TAICHUNG (TW)

(73) Assignee: SYNERBRIDGE LIMITED, TAICHUNG (TW)

(21) Appl. No.: 15/482,861

(22) Filed: Apr. 10, 2017

(51) Int. Cl. C01G 41/00; C09D 7/12; C09D 133/02; C03C 17/00; C03C 17/25

(52) U.S. Cl. CPC C01G 41/006; C09D 7/1216; C09D 7/1266; C03C 2217/22; C03C 17/007; C03C 17/25; C01P 2004/64; C09D 133/02

(57) ABSTRACT

The invention provides a method for preparation of rubidium cesium tungsten bronze particles and a composition of rubidium cesium tungsten bronze particles comprising an organic or inorganic base material, rubidium cesium tungsten bronze particles and additives. The rubidium cesium tungsten bronze particles (RbₓCs_{y})_{0.33}WO_{z} is an alkali metal tungsten oxide material practical for use as a near infrared (NIR) absorbent, thermal mask additive, thermosetting resin or sputtering palladium material. The additive is practical for use in organic or inorganic substrates, such as plastic, paint, enamel, ink, adhesive, ceramic or glass, and prepared, for example, by a plasma torch.

### BACKGROUND OF THE INVENTION

### 1. Field of the Invention

The present invention relates to a method for preparation of rubidium cesium tungsten bronze particles and a composition thereof. The rubidium cesium tungsten bronze particles is an alkali metal tungsten oxide material practical for use as a near infrared (NIR) absorbent, thermal mask additive, thermosetting resin or sputtering palladium material. The additive is practical for use in organic or inorganic substrates, such as plastic, paint, enamel, ink, adhesive, ceramic or glass, and prepared, for example, by a plasma torch.

### 2. Description of the Related Art

It is known that NIR absorption can be achieved by reducing the oxygen content of tungsten oxide (WO₃). This is achieved by exposing the tungsten oxide to the reduced atmosphere at an elevated temperature to form a Magneli phase tungsten suboxide WO3-x. NIR absorption can also be achieved by adding positive ternary to WO₃ under reducing conditions, which results in a tungsten bronze structure, such as the known potassium tungsten bronze and cesium tungsten bronze.

J. Am. Ceram. Soc. 90[12], 4059-4061(2007) discloses nano-scale tungsten oxide particles.

U.S.2005/0271566 discloses nano particles comprising tungsten.

U.S.2008/0308755 teaches polyester fibers containing Cs0.33WO3 particles.

U.S.2008/0116426 teaches light absorbent resin compositions for laser welding.

Therefore, how to develop a more practical and innovative structure is what consumers eagerly look forward to, and is also the goal and direction the relevant industry companies must strive to develop. In view of the situations described above, the inventor, based on years of experience in the design and manufacture of related products and after through detailed design and careful assessment, has finally created the present invention.

### SUMMARY OF THE INVENTION

The present invention has been accomplished under the circumstances in view. It is the main object of the present invention to provide a method for preparation of rubidium cesium tungsten bronze particles by: preparing a powder mixture containing 1 mol of tungsten, 0.01 mol to 5 mol of rubidium and 0.05 mol to 0.5 mol of cesium, and then applying a nanometer grinding process to the powder mixture so as to form a (RbₓCs_{y})_{0.33}WO_{z} powder having a particle size of less than 100 nm. The rubidium cesium tungsten bronze particles are practical for use as a near infrared (NIR) absorbent, thermal mask additive, thermosetting resin or sputtering palladium material. The additive is practical for use in organic or inorganic substrates, such as plastic, paint, enamel, ink, adhesive, ceramic or glass, and prepared, for example, by a plasma torch.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 illustrates the UV-VIS-IR spectroscopy of the transparent thermal insulation film samples of Examples I, II, III and IV made according to the present invention.

### DETAILED DESCRIPTION OF THE INVENTION

The invention provides a method for preparation of rubidium cesium tungsten bronze particles. The rubidium cesium tungsten bronze particles have a chemical formula: (RbₓCs_{y})_{0.33}WO_{z}, where Rb is a rubidium metal element, Cs is a cesium metal element, W is tungsten, O is oxygen, further, x+y≤1.2≤z≤3. The rubidium cesium tungsten bronze particles are a powder mixture. The powder mixture contains, based on 1 mol of tungsten, 0.01 mol to 5 mol of rubidium, and 0.05 mol to 0.5 mol of cesium. The powder mixture is prepared by applying a nanometer grinding process to the (RbₓCs_{y})_{0.33}WO_{z} material so as to form a (RbₓCs_{y})_{0.33}WO_{z} powder having a particle size of less than 100 nm.

The invention also provides a composition of rubidium cesium tungsten bronze particles, comprising an organic or inorganic base material and rubidium cesium tungsten bronze particles having the chemical formula of (RbₓCs_{y})_{0.33}WO_{z}, where x+y≤1.2≤z≤3. The base material is selected from the group of paint, plastic, ink, adhesive, ceramic, glass and enamel.

Preferably, the base material is a near-infrared (NIR) cured coating composition.

Preferably, the base material is a plastic composition in the form of a panel, sheet or thin film. The base material is selected from the group of polycarbonate, polymethylmethacrylate, polyethylene terephthalate, acrylonitrile-butadiene-styrene, polyvinylidene fluoride, styrene-acrylonitrile, polyamide, polystyrene, poly Polybutylene terephthalate, Polyurethane, Polyvinyl butyral, Polyvinyl chloride, Polypropylene, Polyethylene and their blends, alloys and copolymers.

Preferably, the composition contains additives selected from the group of organic phosphorus stabilizers, hindered phenol antioxidants, hydroxylamines, hindered amine light stabilizers, hydroxyphenylbenzotriazole or hydroxyphenyl triazine UV absorbers and other inorganic or organic NIR absorbers.

The rubidium cesium tungsten bronze particles provided by the present invention can be used as a near infrared (NIR) absorbent, thermal mask additive, thermosetting resin or sputtering palladium material.

### EXAMPLE I

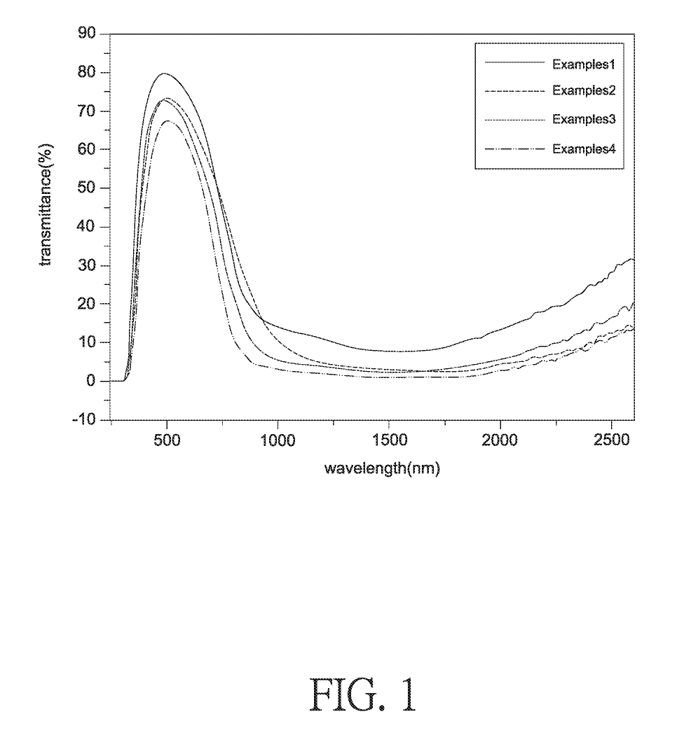

Prepare a transparent thermal insulation material at molar ratio Rb:Cs:W=0.0066:0.3234:3. 10 g ammonium tungstate (manufactured and sold by Sigma-Aldrich) was formulated as an aqueous solution and stirred to obtain a clear liquid A1. 2.17 g cesium carbonate (manufactured by Alfa Aesar) was mixed with 0.031 g rubidium carbonate (manufactured by Alfa Aesar) and stirred to obtain a clear liquid B1. Liquid B1 was further dropped into liquid A1 and stirred uniformly to obtain a transparent mixed liquid C1. The mixed liquid C1 was heated at 180° C. to obtain an initial white powder. The initial white powder was placed in a 10 vol % hydrogen/argon atmosphere at 600° C. for 60-minute reduction to obtain a blue powder. The blue powder was added to a dispersant having a weight of 50 wt % (manufactured by BYK), enabling the mixture to be dispersed in a 2 mm yttrium zirconium beads so as to obtain a nano dispersion liquid D1, and the nano dispersion liquid D1 was mixed with an acrylic resin to form a thermal insulation paint E1. The thermal insulation paint E1 was coated on a glass substrate and dried at 80° C. for half an hour to obtain a transparent thermal insulation film. The transparent thermal insulation film was examined using a UV-VIS-IR spectrophotometer, and the test result was shown in FIG. 1.

### EXAMPLE II

Prepare a transparent thermal insulation material at molar ratio Rb:W=0.33:3. 10 g ammonium tungstate (manufactured and sold by Sigma-Aldrich) was formulated as an aqueous solution and stirred to obtain a clear liquid A1. 1.57 g cesium carbonate (manufactured by Alfa Aesar) was dubbed into an aqueous solution and stirred to obtain a clear liquid B1. Liquid B1 was further dropped into liquid A1 and stirred uniformly to obtain a transparent mixed liquid C1. The mixed liquid C1 was heated at 180° C. to obtain an initial white powder. The initial white powder was placed in a 10 vol % hydrogen/argon atmosphere at 600° C. for 60-minute reduction to obtain a blue powder. The blue powder was added to a dispersant having a weight of 50 wt % (manufactured by BYK), enabling the mixture to be dispersed in a 2 mm yttrium zirconium beads so as to obtain a nano dispersion liquid D1, and the nano dispersion liquid D1 was mixed with an acrylic resin to form a thermal insulation paint E1. The thermal insulation paint E1 was coated on a glass substrate and dried at 80° C. for half an hour to obtain a transparent thermal insulation film. The transparent thermal insulation film was examined using a UV-VIS-IR spectrophotometer and the test result was shown in FIG. 1.

### EXAMPLE III

Prepare a transparent thermal insulation material at molar ratio Rb:Cs:WO=0.165:0.165:0.33. 10 g ammonium tungstate (manufactured and sold by Sigma-Aldrich) was formulated as an aqueous solution and stirred to obtain a clear liquid A1. 1.1 g cesium carbonate (manufactured by Alfa Aesar) was mixed with 0.79 g rubidium carbonate (manufactured by Alfa Aesar) and stirred to obtain a clear liquid B 1. Liquid B1 was further dropped into liquid A1 and stirred uniformly to obtain a transparent mixed liquid C1. The mixed liquid C1 was heated at 180° C. to obtain an initial white powder. The initial white powder was placed in a 10 vol % hydrogen/argon atmosphere at 600° C. for 60-minute reduction to obtain a blue powder. The blue powder was added to a dispersant having a weight of 50 wt % (manufactured by BYK), enabling the mixture to be dispersed in a 2 mm yttrium zirconium beads so as to obtain a nano dispersion liquid D1, and the nano dispersion liquid D1 was mixed with an acrylic resin to form a thermal insulation paint E1. The thermal insulation paint E1 was coated on a glass substrate and dried at 80° C. for half an hour to obtain a transparent thermal insulation film. The transparent thermal insulation film was examined using a UV-VIS-IR spectrophotometer, and the test result was shown in FIG. 1.

### EXAMPLE IV

Prepare a transparent thermal insulation material at molar ratio Rb:Cs:W=0.033:0.297:3. 10 g ammonium tungstate (manufactured and sold by

Sigma-Aldrich) was formulated as a 30 wt % aqueous solution and stirred to obtain a clear liquid A1. 1.98 10 g cesium carbonate (manufactured by Alfa Aesar) was mixed with 0.157 10 g rubidium carbonate (manufactured by Alfa Aesar) to form a 50 wt % aqueous solution and then stirred to obtain a clear liquid B 1. Liquid B1 was further dropped into liquid A1 and stirred uniformly to obtain a transparent mixed liquid C1. The mixed liquid C1 was heated at 180° C. to obtain an initial white powder. The initial white powder was placed in a 10 vol % hydrogen/argon atmosphere at 600° C. for 60-minute reduction to obtain a blue powder. The blue powder was added to a dispersant having a weight of 50 wt % (manufactured by BYK), enabling the mixture to be dispersed in a 2 mm yttrium zirconium beads so as to obtain a nano dispersion liquid D1, and the nano dispersion liquid D1 was mixed with an acrylic resin to form a thermal insulation paint E1. The thermal insulation paint E1 was coated on a glass substrate and dried at 80° C. for half an hour to obtain a transparent thermal insulation film. The transparent thermal insulation film was examined using a UV-VIS-IR spectrophotometer, and the test result was shown in FIG. 1.

From the comparison results of the thermal insulation performance index of the transparent heat insulation films of Examples 1 to 4, we can see that the thermal insulation performance of the transparent thermal insulation film of the alkali metal-based tungsten oxide powder is superior to the thermal insulation performance of the transparent thermal insulation film that simply contains the alkali metal-doped tungsten oxide powder

In view of the above, the transparent thermal insulation material (RbₓCs_{y})_{0.33}WO_{z} of the present invention is an alkali metal tungsten oxide material, and the transparent thermal insulation film made from this transparent thermal insulation material can simultaneously have both high visible light transmittance and high infrared blocking ratio. Further, the transparent thermal insulation film can be made using a low-cost wet coating method.

Although particular embodiments of the invention have been described in detail for purposes of illustration, various modifications and enhancements may be made without departing from the spirit and scope of the invention. Accordingly, the invention is not to be limited except as by the appended claims.

1. (canceled)

2. A composition of rubidium cesium tungsten bronze particles, comprising an organic or inorganic base material, rubidium cesium tungsten bronze particles having the chemical formula of (RbxCsy)_{0.33}WOz, where x+y≤1.2 z≤3 and additives, said base material being selected from the group of paint, plastic, ink, adhesive, ceramic, glass and enamel, said base material being a plastic composition in the form of a panel, sheet or film and selected from the group of polycarbonate, polymethylmethacrylate, polyethylene terephthalate, acrylonitrile-butadiene-styrene, polyvinylidene fluoride, styrene-acrylonitrile, polyamide, polystyrene, poly Polybutylene terephthalate, Polyurethane, Polyvinyl butyral, Polyvinyl chloride, Polypropylene, Polyethylene and blends, alloys and copolymers thereof, said additives being selected from the group of organic phosphorus stabilizers, hindered phenol antioxidants, hydroxylamines, hindered amine light stabilizers, hydroxyphenylbenzotriazole or hydroxyphenyl triazine UV absorbers and the relative inorganic or organic NIR absorbers, said ubidium cesium tungsten bronze particles being adapted for use as a near infrared (NIR) absorbent, thermal mask additive, thermosetting resin or sputtering palladium material.
